(19) United States
(12) Patent Application Publication
(10) Pub. No.: US 2014/0344641 A1
(43) Pub. Date: Nov. 20, 2014

(54) MEMORY SYSTEM AND CACHE MANAGEMENT METHOD OF THE SAME

(71) Applicant: Samsung Electronics Co., Ltd., Suwon-si (KR)

(72) Inventors: HAYOUNG JEONG, Seoul (KR); MOONGYUNG KIM, Suwon-si (KR)

(73) Assignee: Samsung Electronics Co., Ltd., Suwon-si (KR)

(21) Appl. No.: 14/227,496

(22) Filed: Mar. 27, 2014

(30) Foreign Application Priority Data
May 14, 2013 (KR) 10-2013-0054459

(51) Int. Cl. G06F 11/07; G06F 12/08

(52) U.S. Cl. CPC G06F 11/073; G06F 12/0864
USPC 714/759

(57) ABSTRACT

A memory system includes data lines, cache lines temporarily storing data of the data lines, an error correction circuit reading the data stored in each of the cache lines, detecting or correcting errors in the read data, calculating error rates according to each type of the detected errors, and accumulating the calculated error rates on previous error rates, an error rate table storing the accumulated error rates, and a line allocator allocating the cache lines corresponding to the data lines by using the error rate table, wherein cache lines whose accumulated error rates are greater than a predetermined value are not allocated.

### CROSS-REFERENCE TO RELATED APPLICATIONS

This U.S. non-provisional patent application claims priority under 35 U.S.C. §119 to Korean Patent Application No. 10-2013-0054459, filed on May 14, 2013, the disclosure of which is incorporated by reference in its entirety herein.

### BACKGROUND

1. Technical Field

Embodiments of the inventive concept relate to a memory system and a method of managing a cache of the memory system.

2. Discussion of Related Art

A cache memory of a computer is used to reduce the average time to access memory. The cache is a smaller, faster memory which stores copies of the data from frequently used main memory locations. However, the average time to access the memory may increase when data is stored in the cache with an error or when physical parts of the cache are faulty.

### SUMMARY

Embodiments of the inventive concept provide a memory system that can detect hardware errors during an operation of the system and a method of managing a cache of the memory system.

According to an exemplary embodiment of the inventive concept, a memory system includes: data lines; cache lines temporarily storing data of the data lines; an error correction circuit reading the data stored in each of the cache lines, detecting or correcting errors in the read data, calculating error rates according to each type of the detected errors, and accumulating the calculated error rates on previous error rates; an error rate table storing the accumulated error rates; and a line allocator allocating the cache lines corresponding to the data lines by using the error rate table, wherein cache lines whose accumulated error rates are greater than a predetermined value are not allocated.

In an exemplary embodiment, the data lines and the cache lines may be mapped by a set associative scheme.

In an exemplary embodiment, the line allocator may allocate the cache lines by using set information, line information, and the error rate table, wherein the set information is used for selecting a set of the cache lines, the line information is used for selecting cache lines from the selected set, and the error rate table comprises error rates of the selected cache lines.

In an exemplary embodiment, the error correction circuit may include, an error detector and corrector detecting or correcting errors in the read data by using an error correction code; an error rate calculator calculating error rates according to a type of the detected errors, accumulating the calculated error rates based on the previous error rates read from the error rate table, and updating the error rate table with the accumulated error rates; and a hardware error detector generating a hardware error signal when an accumulated error rate of any one cache line, which is read from the error rate table, is greater than a predetermined value.

In an exemplary embodiment, the error rate calculator may include weights for different error rates according to different error types.

In an exemplary embodiment, when the accumulated error rate of any one cache line is greater than the predetermined value, the error rate calculator may write an access inhibition mark with a predetermined bit value in a region corresponding to the cache lines in the error rate table.

In an exemplary embodiment, the line allocator may prevent cache lines from being allocated in response to the hardware error signal.

In an exemplary embodiment, when the number of cache lines having access inhibition marks written by using the error rate table is greater than a predetermined value, the hardware error detector may generate a system fault signal.

In an exemplary embodiment, when operation conditions are changed, the error rate table may be reset.

In an exemplary embodiment, when an operating voltage or an operating frequency is changed, the error rate table may be reset.

In an exemplary embodiment, the memory system may further include a nonvolatile memory used for periodically backing up the error rate table.

In an exemplary embodiment, the error rate table may be configured with some of the cache lines and some regions of each of the cache lines may store a corresponding accumulated error rate.

According to an exemplary embodiment of the inventive concept, a method of managing a cache of a memory system including cache lines, a central processing unit accessing the cache lines, and an error rate table storing an error rate for each of the cache lines includes: allocating a cache line to be accessed by using the error rate table; storing data in the allocated cache line; reading data from the allocated cache line, detecting or correcting errors in the read data; calculating error rates on the basis of the detected or corrected errors; and updating the error rate table by accumulating the calculated error rates based on previous error rates.

In an exemplary embodiment, the method may further include: determining whether operation conditions are changed; and, when the operation conditions are changed, resetting the error rate table.

In an exemplary embodiment, the method may further include periodically backing up the error rate table on a nonvolatile memory.

According to an exemplary embodiment of the invention, a memory system includes a cache, an error detection and correction circuit, a table, an error calculator, and a line allocator. The cache includes a plurality of cache lines to temporally store data. The error detection and correction circuit reads data stored in a given one of the cache lines and outputs a current type indicating one of i) the data has no error, ii) the data has an error that was corrected, and iii) the data has an error that could not be corrected. The table includes an entry for each cache line. The error calculator generates an error value by accumulating the current type with a previous type received for the one cache line and stores the error value in the entry of the table corresponding to the one cache line. The line allocator denies access to the one cache line when the error value in the entry is greater than a predetermined value and otherwise enables access to the one cache line.

In an exemplary embodiment, the type indicating the data has no error is a first value, the type indicating the data had an error that was corrected is a second value, and the type indicating the data has an error that could not be corrected is a third value, where the first value is less than the second value and the second value is less than the third value.

In an exemplary embodiment, the line allocator is a logic unit that receives a first signal that indicates whether the error value is greater than the predetermined value and a second signal indicating whether a write is to be performed.

In an exemplary embodiment, the calculator stores a maximum value supported by the entry in the entry when the error value is greater than the predetermined value.

In an exemplary embodiment, each entry in the table is cleared when an operating condition of the system changes from a first state to a second other state.

### BRIEF DESCRIPTION OF THE DRAWINGS

The drawings illustrate exemplary embodiments of the inventive concept. In the drawings:

FIG. 1 is a view schematically illustrating a memory system for explaining an exemplary embodiment of the inventive concept;

FIG. 2 is a view illustrating exemplary error rate weights according to a kind of error used in the error rate calculator of FIG. 1;

FIG. 3 is a view illustrating an exemplary memory system for explaining a cache management method according to an embodiment of the inventive concept;

FIG. 4 is a flow chart illustrating a cache management method according to an exemplary embodiment of the inventive concept;

FIG. 5 is a flow chart illustrating a cache management method according to an exemplary embodiment of the inventive concept;

FIG. 6 is a flow chart illustrating a method of managing an error rate table according to an exemplary embodiment of the inventive concept;

FIG. 7 is a block diagram illustrating a memory system according to an exemplary embodiment of the inventive concept;

FIG. 8 is a block diagram illustrating a solid state drive (SSD) according to an exemplary embodiment of the inventive concept;

FIG. 9 is a block diagram illustrating an embedded multimedia card (eMMC) according to an exemplary embodiment of the inventive concept;

FIG. 10 is a block diagram illustrating a universal flash storage (UFS) system according to an exemplary embodiment of the inventive concept; and

FIG. 11 is a block diagram illustrating a mobile device according to an exemplary embodiment of the inventive concept.

### DETAILED DESCRIPTION

Exemplary embodiments of the inventive concept will be described below in more detail with reference to the accompanying drawings. The inventive concept may, however, be embodied in different forms and should not be construed as limited to the embodiments set forth herein.

A memory system according to an exemplary embodiment of the inventive concept detects hardware errors by analyzing soft errors by using an ERror rate table (ERT) storing accumulated error rates.

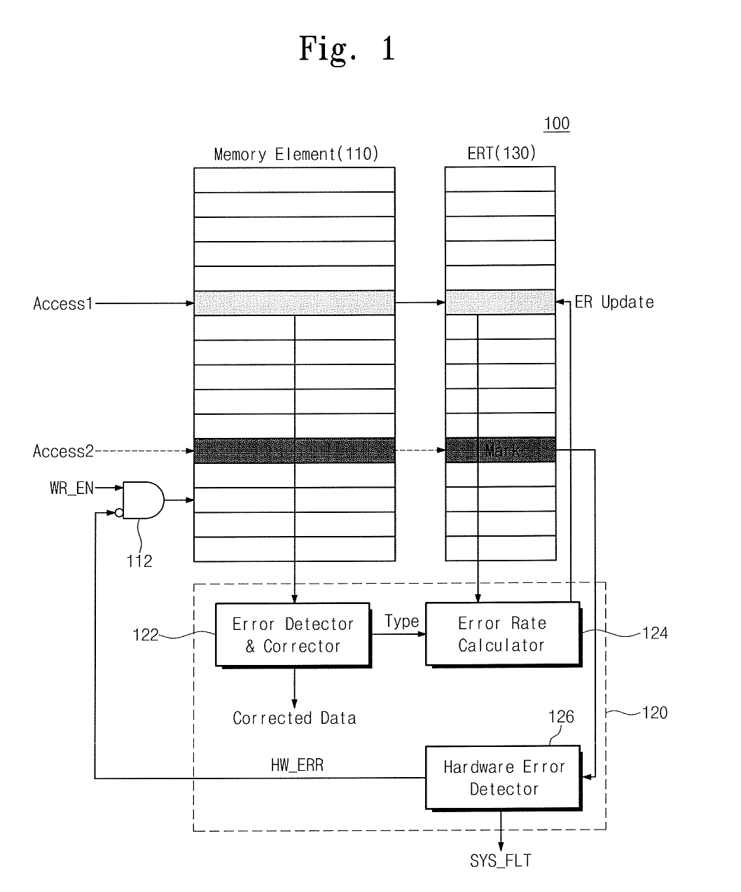

FIG. 1 is a view schematically illustrating a memory system 100 for explaining an exemplary embodiment of the inventive concept. Referring to FIG. 1, the memory system 100 includes a plurality of memory elements 110, an error correction circuit 120, and an ERT 130.

The memory elements 110 may be respectively implemented to store predetermined data. In an embodiment, the memory element 110 may be respectively implemented with at least one of a volatile memory and a nonvolatile memory. In an embodiment, the predetermined data may include an error correction code for error correction.

As shown in FIG. 1, enabling a write operation in each of the memory elements 110 may be determined by combination of a write enable signal WR_EN and a hardware error signal HW_ERR. For example, if the write enable signal WR_EN indicates a write should be performed (e.g., WR_EN is activated) and the hardware error signal HW_ERR indicates that no error is present (e.g., HW_ERR is deactivated), a corresponding one of the memory elements can be written. For example, if the write enable signal WR_EN is deactivated (indicating a write should not be performed) or the hardware error signal HW_ERR is activated (indicating an error has occurred), the one memory element is not written. The memory system 100 may further include respective logic circuits 112 corresponding to the memory elements 110 for determining whether to enable the write operation. In an exemplary embodiment, the logic circuits 112 receive the write enable signal WR_EN and the hardware error signal HW_ERR and generate a signal for determining whether to enable the write operation.

The error correction circuit 120 may detect and/or correct errors of data stored in the memory elements 110 by using an error correction code. The error correction circuit 120 includes an error detector/corrector 122, an error rate calculator 124, and a hardware error detector 126.

The error detector/corrector 122 reads data stored in any one memory element, and detects or corrects errors in the read data. The error detector/corrector 122 may output error information on the read data. In an exemplary embodiment, the output error information includes a type of error. In an exemplary embodiment, the type of error indicates whether the error is a soft error or a hard error. For example, a soft error can occur while data is transmitted along a data line and exposed to noise, which could cause one or more bits of the data to be incorrectly interpreted as being set or cleared. A hard error may indicate that a physical part of memory has an abnormality that prevents that part from accurately storing data. For example, if that part is configured to store bits of data, and one or more of its bit is always stuck (e.g., is always 0 or always 1, regardless of the value of the data bit written) or is frequently stuck, it is likely that hard errors will be encountered when data is written to that part. In another example, the type of error indicates at least one of whether no error is present, whether an error that has occurred is correctable, whether an error that has occurred has been corrected, whether an error that has occurred is not correctable, etc.

The error rate calculator 124 calculates an error rate (ER) based on the error information (e.g., the type of error output from 122). For example, when there is no error in the read data, an ER is 0. When errors are present in the read data and the errors are corrected, an ER may be 1. When errors are present in the read data but the errors are not corrected, an ER may be 2. While the above describes use of values such as 0-2 for three different types, the invention concept is not limited to any number of types and their values may vary. The calculated ER is accumulated based on a previous ER and the ERT 130 may be updated by the ER calculator 124.

In an embodiment, when an accumulated ER is greater than a predetermined value, the ER calculator 124 may write an access inhibition mark in a corresponding memory element in the ERT 130. A memory element may include one or more cache lines (e.g., a cache line region). For example, the access inhibition mark may be a maximum value (for example, “1 . . . 1”) of bits for representing the ER. For example, if the predetermined value is 2, and data is read from a memory element five times sequentially, and during two of these times no error occurred and during the remaining three time, errors occurred and were corrected, the accumulated ER would be 3 (e.g., 0+0+1+1+1), and thus the memory element would have an access inhibition mark.

The hardware error detector 126 generates a hardware error signal (HW_ERR) for a memory element in which an ER exceeds a predetermined value on the basis of the ERT 130. For example, the hardware error detector 126 may determine whether an ER corresponding to a memory element, which corresponds to an address in a write operation, is greater than a predetermined value, and generate a hardware error signal HW_ERR according to the determination result. That is, the hardware error detector 126 may generate the hardware error signal HW_ERR to prevent use of a cache line having an access inhibition mark written. For example, the hardware error detector 126 may activate the hardware error signal HW_ERR for a memory element when a corresponding entry in the ERT 130 has an access inhibition mark and deactivate the hardware error signal HW_ERR otherwise.

In addition, the hardware error detector 126 may generate a system fault signal SYS_FLT by using the ERT 130, when the number of cache lines, having the access inhibition mark written, is greater than a predetermined value. For example, when the access inhibition marks are written to all cache lines or a majority of the cache lines, the system fault signal SYS_FLT may be generated.

The ERT 130 may store ERs respectively corresponding to memory elements 110. The stored ERs may be calculated and accumulated by the error rate calculator 124.

In an embodiment, the ERT 130 is configured in some of the memory elements 110. For example, each or part of the memory elements 110 may be implemented to include regions in which the accumulated ERs are stored.

In an exemplary embodiment, the ERT 130 is stored in a volatile memory or a nonvolatile memory.

The memory system 100 may include a portion to detect hardware errors (e.g., hard errors) or soft errors of memory elements, which occur after product loading. The portion operates statically so that errors are exceptionally handled every time the errors occur or error occurrences are recorded and corresponding memory lines are prevented from being accessed. Alternately, the memory system 100 according to an exemplary embodiment of the inventive concept, can discriminate among error types of repetitively occurring errors and intermittently occurring errors according to operation conditions of a chip, and detect and process the errors by including the ERT 130 in which accumulated ERs are stored. The ERs may be calculated from soft errors that occurred during driving of the memory system 100

Furthermore, the memory system 100 according to at least one embodiment of the inventive concept can efficiently use memory elements during runtime by variably discriminating among soft errors and hard errors according to operation conditions. Here, the operation conditions may be at least one of various conditions such as an external voltage, an operating frequency, a temperature, and a consumed current amount.

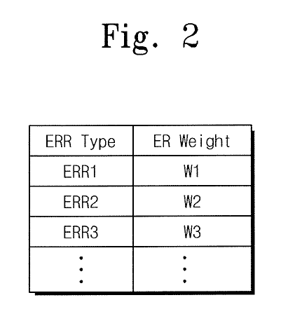

FIG. 2 illustrates exemplary ER weights according to an error type, which may be used in the ER calculator 124 of FIG. 1. Referring to FIG. 2, a first error ERR1 may be calculated as an ER of a first weight W1, a second error ERR2 may be calculated as an ER of a second weight W2, and a third error ERR3 may be calculated as an ER of a third weight W3. Here, the first, second, and third weights W1, W2, and W3 may be different values.

For example, the first error ERR1 corresponds to one bit detection data, the second error ERR2 corresponds to one bit detection and correction data, and the third error ERR3 corresponds to two bit error detection data.

The ERT 130 according to an exemplary embodiment of the inventive concept is managed to have ERs having different weights according to different error types.

The inventive concept may be also applicable to a cache management method. In particular, the inventive concept may be applied to a set associative cache. Here, the set associative cache includes a plurality of sets formed of a predetermined number of cache lines. A single memory line corresponds to a set among the plurality of sets, and is mapped into any one of a plurality of cache lines of the corresponding set.

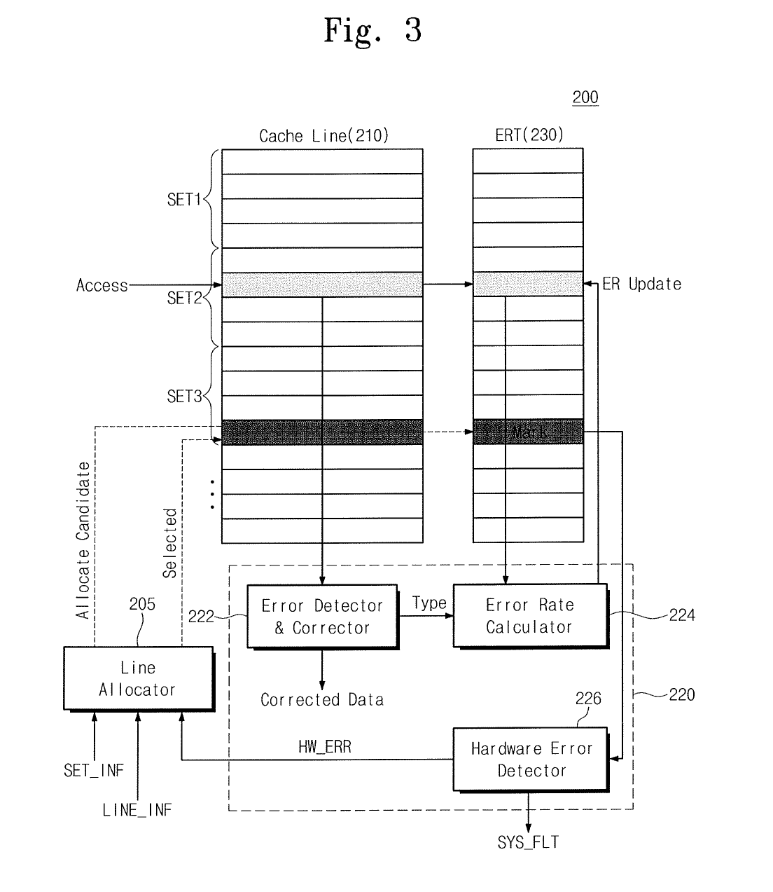

FIG. 3 illustrates an exemplary memory system 200 for explaining a method of managing a cache according to an exemplary embodiment of the inventive concept. Referring to FIG. 3, the memory system 200 includes a line allocator 205, cache lines 210, an error correction circuit 220, and an error rate table (ERT) 230.

The line allocator 205 allocates a cache line corresponding to any one memory line in response to set information SET_INF, line information LINE_INF, and a hardware error signal HW_ERR. The set information SET_INF is for selecting a set of cache lines, and the line information LINE_INF is on a cache line to be mapped in the selected set. The hardware error signal HW_ERR is a hardware error detecting signal generated from the error correction circuit 220.

In an embodiment, a cache line candidate is allocated on the basis of the set information SET_INF and line information LINE_INF.

In an embodiment, the allocated cache line candidate is selected in response to the hard error signal HW_ERR. Accordingly, a cache line to be used is finally allocated.

In an embodiment, the line allocator 205 may be implemented to preferentially allocate a cache line having a low error rate by using the ERT 230 from among the selected set. For example, among cache lines of a given set, one of the cache lines can be chosen that has a lowest corresponding value in the ERT 230. Although not shown in the drawing, the ERs may be managed for each set. In this case, the line allocator 205 may be implemented to select the set on the basis of ER information corresponding to each set.

FIG. 3 illustrates each cache set among the cache lines 210 including four cache lines (e.g., see SET1, SET2, SET3). However, the inventive concept is not limited thereto. For example, each cache set may include less than four lines or greater than four lines.

The error correction circuit 220 includes elements 222, 224, and 246, which have the same configuration as elements 122, 124, and 126 of the error correction circuit 120 shown in FIG. 1, respectively. For example, element 222 performs the function of the error detector & corrector 122, element 224 performs the function of the error rate calculator 124, and element 226 performs the function of the hardware error detector 126.

The ERT 230 may accumulate ERs for the respective cache lines 210. The ERT 230 may be implemented to be the same as the ERT 130 shown in FIG. 1. In FIG. 3, the ERT 230 is illustrated as being separate from the cache lines 210. However, the inventive concept is not limited hereto. The ERT 230 may be included in the cache lines 210. For example, each of the cache lines 210 may include a field for storing and accumulating an ER of each cache line.

Furthermore, in FIG. 3, ERs are calculated and accumulated by detecting/correcting errors of data stored in the cache lines. However, the accumulated ERs of the inventive concept are not limited thereto. In addition, the accumulated ERs may further include ERs related to detection/correction of errors of data stored in any place corresponding to data stored in the cache lines. For example, the ERs may be accumulated in relation to detection/correction of data errors of data lines corresponding to cache lines.

The memory system 200 according to an exemplary embodiment of the inventive concept classifies a type of errors detected in the error correction circuit 220, determines whether the errors are hardware errors according to the classified result, and determines whether to allocate the cache lines according to the determined result.

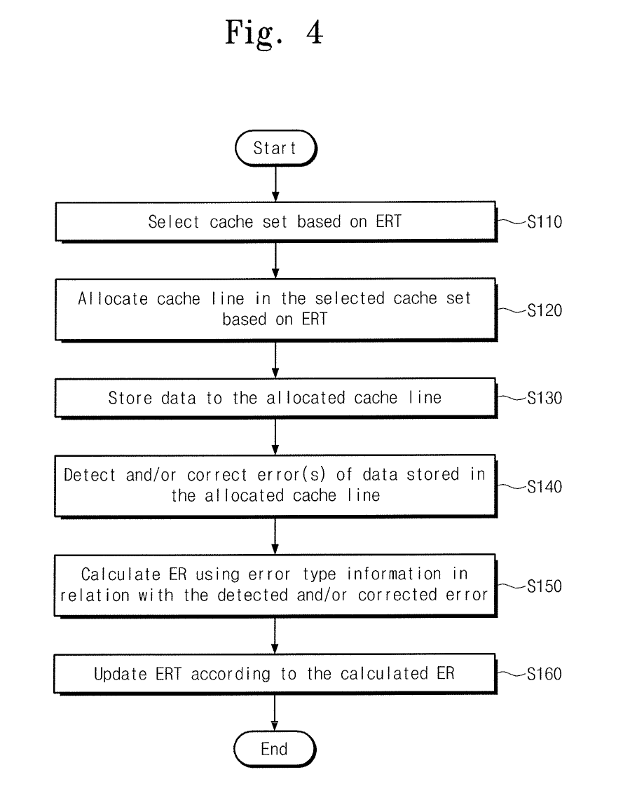

FIG. 4 is a flow chart illustrating a method of managing a cache according to an exemplary embodiment of the inventive concept. Referring to FIGS. 3 and 4, the cache management method is as follows.

A cache set is selected on the basis of the ERT (operation S110). A cache line having the lowest ER is allocated in a cache set selected on the basis of the ERT (operation S120). Data (or instructions) of a corresponding memory line is stored in the allocated cache line (operation S130). Errors in the data stored in the allocated cache line are detected and/or corrected (operation S140). ERs are calculated by using error type information related to the detection and/or correction of the errors (operation S150). The ERT is updated according to the calculated ERs (operation S160).

The cache management method according to an exemplary embodiment of the inventive concept may allocate cache lines on the basis of the ERT storing the ERs of the cache lines.

However, the cache management method according to an exemplary embodiment of the inventive concept may be varied according to changes of operation conditions.

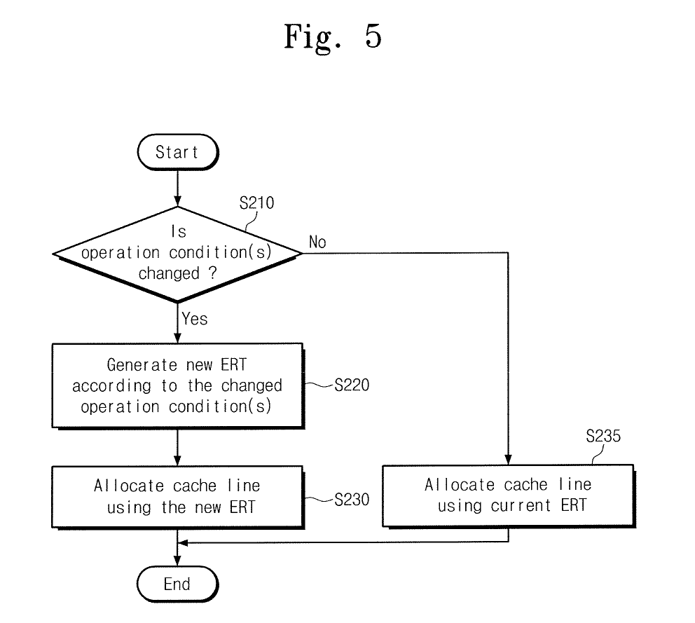

FIG. 5 is a flow chart illustrating a method of managing a cache according to an exemplary embodiment of the inventive concept. Referring to FIGS. 3 and 5, the cache management method is as follows.

It is determined whether an operation condition (or multiple operation conditions) is changed (operation S210). Here, the operation condition may be at least one of various conditions such as an external voltage, operating voltage, an operating frequency, a temperature, a consumed current amount. When the operation condition is changed, a new ERT is generated according to the changed operation condition (operation S220). For example, creation of a new ERT could mean that a current ERT is reset or cleared. Then, the cache lines are allocated using the new ERT (S230). In contrast, when the operation condition is not changed, cache lines are allocated by using the current ERT (operation S235).

In the cache management method according to an exemplary embodiment of the inventive concept, an ERT is reset according to a change of the operation condition, and the cache lines are allocated on the basis of the new ERT.

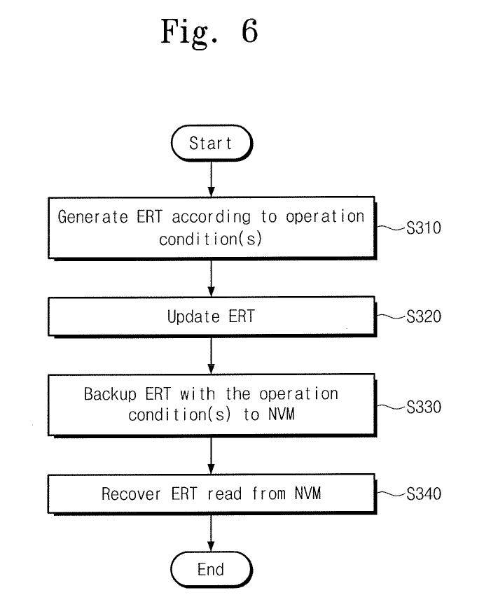

FIG. 6 is a flow chart illustrating a method of managing an ERT according to an exemplary embodiment of the inventive concept. Referring to FIG. 6, the ERT management method is as follows. An ERT is generated according to any one operation condition (or multiple operation conditions) (operation S310). The ERT is updated according to cache management (operation S320). The ERT is backed up with the operation conditions to a nonvolatile memory (NVM) periodically or based on a user's request (operation S330). When a power supply is turned off and then turned on, the ERT backed up to the NVM is recovered (operation S340). Then, cache lines may be allocated on the basis of the recovered ERT. For example, if the change in operation condition that triggers creation of a new ERT is a change in operating voltage to a value outside a certain voltage range, the condition may also be backed up along with the ERT. Further, when the ERT is restored, the condition can also be restored so that the system knows what condition should be evaluated to determine whether the restored ERT should be reset.

The ERT according to an exemplary embodiment of the inventive concept may be backed up to NVM in preparation for a power-off.

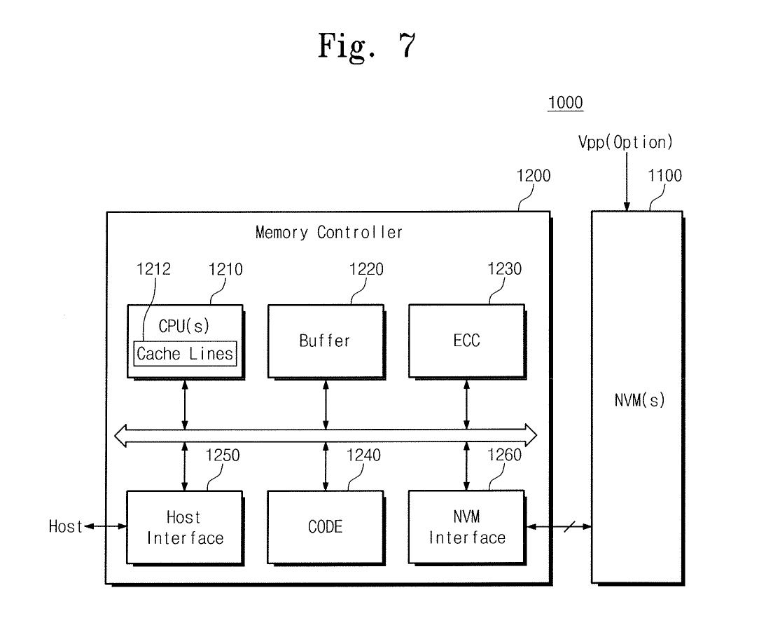

FIG. 7 is a block diagram illustrating a memory system according to an exemplary embodiment of the inventive concept. Referring to FIG. 7, the memory system 1000 includes at least one nonvolatile memory (NVM) 1100 and a memory controller 1200.

The nonvolatile memory device 1100 optionally receives a high voltage Vpp from the outside. The memory controller 1200 may be connected to the NVM 1100 through a plurality of channels. The memory controller 1200 includes at least one central processing unit (CPU) 1210, a buffer memory 1220, an error correction circuit (ECC) 1230, a code memory 1240, a host interface 1250, and a NVM interface 1260.

The CPU 1210 may include cache lines 1212. Here, the cache lines 1212 may be allocated according to the ERs as shown in FIGS. 1 to 6. The cache lines 1212 may be implemented in any one method of various mapping schemes of associative cache, direct map cache, set associative cache, and sector map cache.

The buffer memory 1220 may temporarily store data necessary for driving of the memory controller 1200. In an embodiment, the buffer memory 1220 includes a plurality of memory lines storing data or instructions. Here, the plurality of memory lines may be mapped to the cache lines 1212 in various schemes.

The error correction circuit 1230 may calculate an error correction code value for data to be programmed in a write operation, correct errors in data read in a read operation on the basis of the error correction code value, and correct errors in data recovered from the NVM 1100 in a data recovering operation. In addition, the error correction circuit 1230 may be implemented to detect and correct errors in data (for example, data stored in cache lines or data lines) corresponding to cache lines according to an error correction code, determine an error type generated in each cache line, and calculate and accumulate ERs for each error type. The error correction circuit 1230 may include the error correction circuit 220 shown in FIG. 3.

The code memory 1240 stores code data necessary for driving the memory controller 1200. The code memory 1240 may be implemented with nonvolatile memories. In an exemplary embodiment, the code memory 1240 is implemented to back up the ERT. The host interface 1250 may include an interface function to interface with external devices. The nonvolatile memory interface 1260 may include an interface function to interface with the NVM 1100.

The memory system 1000 in an exemplary embodiment of the inventive concept processes hardware errors during operation by determining frequently recurring soft errors to be hardware errors by using the ERs.

The inventive concept may be applicable to a solid state drive (SSD).

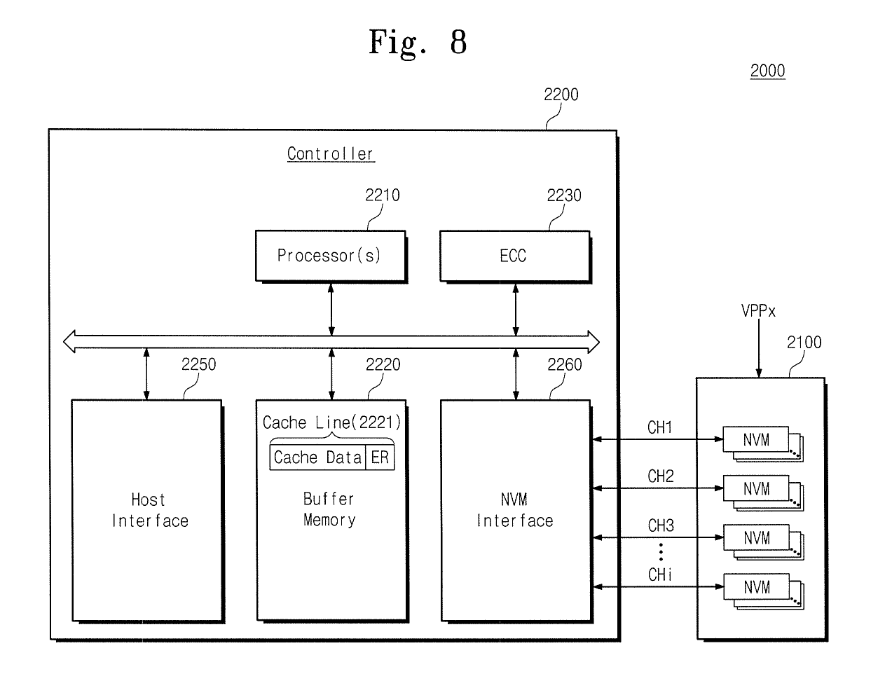

FIG. 8 is a block diagram illustrating an SSD according to an exemplary embodiment of the inventive concept.

Referring FIG. 8, the SSD 2000 includes a plurality of NVMs 2100 and an SSD controller 2200. The NVMs 2100 may be implemented to optionally receive an external high voltage Vpp. In an exemplary embodiment, the NVMs 2100 are flash memory devices.

The SSD controller 2200 is connected to the NVMs 2100 through a plurality of channels CH1, CH2, CH3, . . . , CHi, where i is an integer. The SSD controller 2200 includes at least one processor 2210, a buffer memory 2220, an error correction circuit 2230, a host interface 2250, and a NVM interface 2260.

The buffer memory 2220 may include a plurality of cache lines 2221. Each of the plurality of cache lines 2221 may be implemented to store cache data and ERs of the cache data. Here, the ER is a value according to an error type and may be changed according to operation conditions. As described in relation to FIGS. 1 to 6, the ERs may be accumulated for each cache line. According to the accumulated ERs, it may be determined whether the cache lines are allocated (or used). That is, the processor 2210 may access the cache lines according to the ERs. In FIG. 8, the cache lines are included in the buffer memory 2220, but the inventive concept is not limited hereto. For example, the cache lines 2221 in an exemplary embodiment of the inventive concept may be implemented to be included inside the processor 2210.

The SSD 2000 according to an exemplary embodiment of the inventive concept may process data stably, since it uses cache lines on the basis of the ERs.

The inventive concept may be applicable to an embedded multimedia card (eMMC), a moviNAND, or an iNAND.

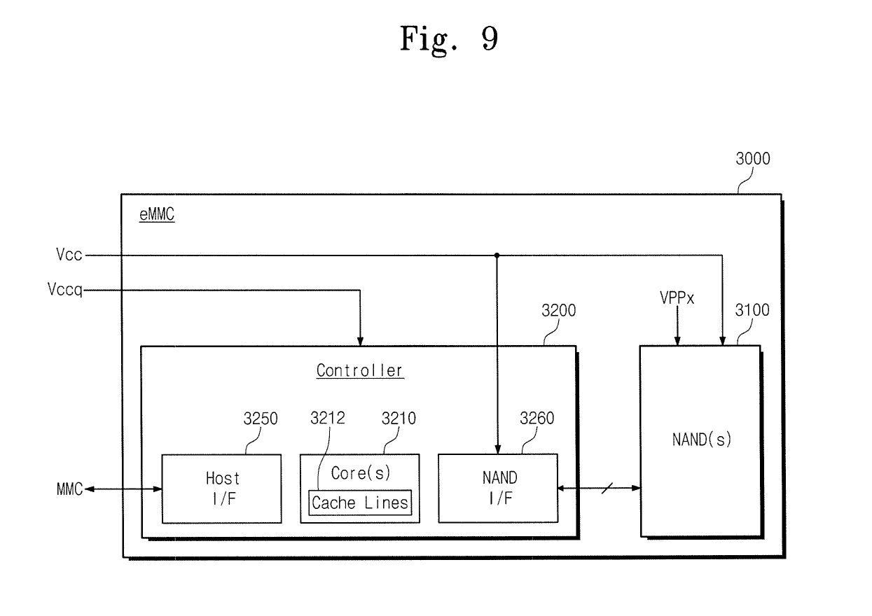

FIG. 9 is a block diagram illustrating an eMMC according to an exemplary embodiment of the inventive concept. Referring to FIG. 9, the eMMC 3000 includes at least one NAND flash memory 3100 and a controller 3200.

The NAND flash memory 3100 may be a single data rate (SDR) or double data rate (DDR) NAND flash memory. In an embodiment, the NAND flash memory 3100 includes unit NAND flash memories. In an embodiment, the unit NAND flash memories are implemented to be stacked in a single package (for example, fine-pitch ball grid array). The NAND flash memory 3100 may be a vertical NAND. The memory controller 3200 is connected to the NAND flash memory 3100 through one or more channels. The memory controller 3200 includes at least one controller core 3210, a host interface 3250, and a NAND interface 3260. The at least one controller core 3210 controls the entire operation of the eMMC 3000.

The controller core 3210 may include a plurality of cache lines 3212. The cache lines 3212 may be implemented to be allocated on the basis of the accumulated ERs as described in relation to FIGS. 1 to 6.

The host interface 3250 performs interfacing of a host with the memory controller 3210. The NAND interface 3260 performs interfacing of the NAND flash memory 3100 and the memory controller 3200. In an embodiment, the host interface 3250 is a parallel interface (for example, an MMC interface). In another embodiment, the host interface 3250 of the eMMC 3000 is a serial interface (for example, a UHS-II or universal flash storage (UFS) interface)

The eMMC 3000 receives power supply voltages Vcc and Vccq from the host. Here, a first power supply voltage Vcc (for example, 3.3V) is provided to the NAND flash memory 3100 and the NAND interface 3200, and a second power supply voltage Vccq (for example, 1.8V/3.3V) is provided to the controller 3200. In an embodiment, the eMMC 3000 optionally receives an external high voltage Vpp.

The eMMC 300 according to an embodiment of the inventive concept may accumulate ERs changed according to operation conditions, and allocate cache lines in order to achieve optimal performance according to the accumulated ERs.

The inventive concept may be applicable to the UFS.

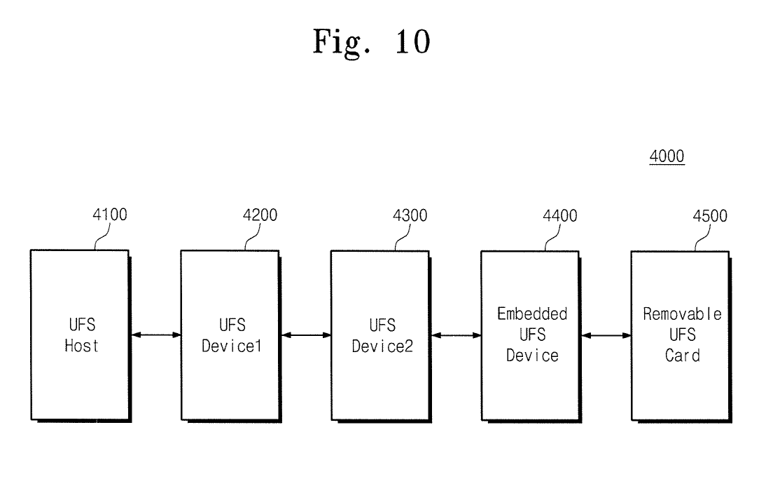

FIG. 10 is a block diagram illustrating an exemplary UFS system according to an exemplary embodiment of the inventive concept. Referring to FIG. 10, the UFS system 4000 includes a UFS host 4100, UFS devices 4200 and 4300, an embedded UFS device 4400, and a removable UFS card 4500. The UFS host 4100, the UFS devices 4200 and 4300, the embedded UFS device 4400, and the removable UFS card 4500 may respectively communicate with external devices through a UFS protocol. At least one of the UFS devices 4200 and 4300, the embedded UFS device 4400, and the removable UFS card 4500 may be implemented with the memory system 100 shown in FIG. 1 or the memory system 200 shown in FIG. 3.

Furthermore, the embedded UFS device 4400 and the removable UFS card 4500 may perform a communication through a protocol other than the UFS protocol. The UFS host 4100 and the removable UFS card 4500 may perform a communication using various card protocols (for example, universal flash devices (UFDs), MMC, secure digital (SD), mini SD, or micro SD).

The inventive concept may be applicable to mobile devices.

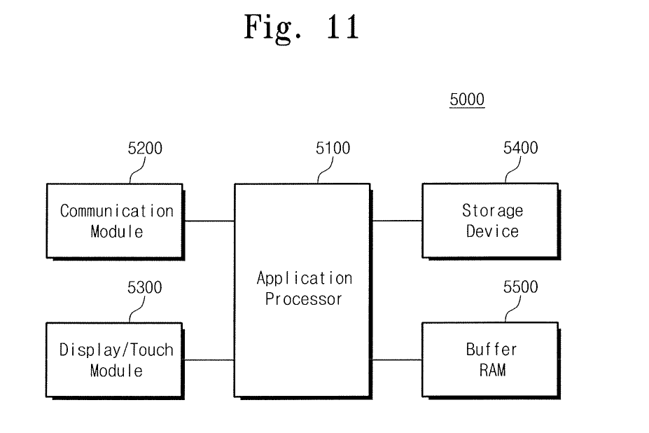

FIG. 11 is a block diagram illustrating a mobile device 5000 according to an exemplary embodiment of the inventive concept. Referring to FIG. 11, the mobile device 5000 includes an application processor 5100, a communication module 5200, a display/touch module 5300, a storage device 5400, and a mobile RAM 5500.

The application processor 5100 controls entire operations of the mobile device 5000. The communication module 5200 may be implemented to control wired/wireless communication with the outside. The display/touch module 5300 may be implemented to display data processed by the application processor 5100 or receive data from a touch panel. The storage device 5400 may be implemented to store user data. The storage device 5400 may be an eMMC, an SSD, or a UFS device. The mobile RAM 5500 may be implemented to temporarily store data necessary for operations of the mobile device 5000. The mobile RAM 5500 may be implemented in at least one of the memory element allocation method as illustrated in FIG. 1 and the cache line allocation method illustrated in FIG. 3.

The mobile device 5000 according to an embodiment of the inventive concept can enhance systematic performance by detecting and processing hardware errors.

The memory system or the storage device according to an embodiment of the inventive concept may be embedded by using various types of packages. In an embodiment, the memory system or storage device may be embedded by using various types of packages such as, package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline (SOIC), shrink small outline package (SSOP), thin small outline package (TSOP), thin quad flat pack (TQFP), system in package (SIP), multi chip package (MCP), wafer-level fabricated package (WFP), or wafer-level processed stack package (WSP).

As described above, a memory system according to at least one embodiment of the present inventive concept can detect and process hardware errors during operation by using an ERT which stores accumulated ERs.

At least one embodiment of the inventive concept can be embodied as computer-readable codes having computer executable instructions on a computer-readable medium. For example, the operations of FIG. 4, FIG. 5, and FIG. 6 may be embodied as computer executable instructions. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices.

While the inventive concept has been described with reference to exemplary embodiments thereof, various modifications may be made to these embodiments without departing from the spirit and scope of the present invention.

What is claimed is:

1. A memory system comprising:
a plurality of data lines;
a plurality of cache lines configured to temporarily store data of the data lines;
an error correction circuit configured to read the data stored in each of the cache lines, detect or correct errors in the read data, calculate error rates according to each type of the detected errors, and accumulate the calculated error rates based on previous error rates;
an error rate table configured to store the accumulated error rates; and
a line allocator configured to allocate the cache lines corresponding to the data lines by using the error rate table,
wherein cache lines whose accumulated error rates are greater than a predetermined value are not allocated.

2. The memory system of claim 1, wherein the data lines and the cache lines are mapped by a set associative scheme.

3. The memory system of claim 2, wherein the line allocator allocates the cache lines by using set information, line information, and the error rate table,
wherein the set information is used for selecting a set of the cache lines, the line information is used for selecting cache lines from the selected set, and the error rate table comprises error rates of the selected cache lines.

4. The memory system of claim 1, wherein the error correction circuit comprises:
an error detector and corrector configured to detect or correct errors in the read data by using an error correction code;
an error rate calculator configured to calculate error rates according to a type of the detected errors, accumulate the calculated error rates based on the previous error rates read from the error rate table, and update the error rate table with the accumulated error rates; and
a hardware error detector configured to generate a hardware error signal when an accumulated error rate of any one cache line, which is read from the error rate table, is greater than the predetermined value.

5. The memory system of claim 4, wherein the error rate calculator comprises weights for different error rates according to different error types.

6. The memory system of claim 4, wherein, when the accumulated error rate of any one cache line is greater than the predetermined value, the error rate calculator writes an access inhibition mark with a predetermined bit value in a region corresponding to the cache lines in the error rate table.

7. The memory system of claim 4, wherein the line allocator prevents cache lines from being allocated in response to the hardware error signal.

8. The memory system of claim 4, wherein, when the number of cache lines having access inhibition marks written by using the error rate table is greater than a predetermined value, the hardware error detector generates a system fault signal.

9. The memory system of claim 1, wherein, when an operation condition changes, the error rate table is reset.

10. The memory system of claim 9, wherein the operating condition is an operating voltage or an operating frequency.

11. The memory system of claim 1, further comprising a nonvolatile memory used for periodically backing up the error rate table.

12. The memory system of claim 1, wherein the error rate table is configured with some of the cache lines, and some regions of each of the cache lines store a corresponding accumulated error rate.

13. A method of managing a cache of a memory system comprising cache lines, a central processing unit configured to access the cache lines, and an error rate table configured to store an error rate for each of the cache lines, the method comprising:
allocating a cache line to be accessed by using the error rate table;
storing data in the allocated cache line;
reading data from the allocated cache line;
detecting or correcting errors in the read data;
calculating error rates based on the detected or corrected errors; and
updating the error rate table by accumulating the calculated error rates based on previous error rates.

14. The method of claim 13, further comprising:
determining whether operation conditions are changed; and
when the operation conditions are changed, resetting the error rate table.

15. The method of claim 13, further comprising periodically backing up the error rate table on a nonvolatile memory.

16. A memory system comprising:
a cache comprising a plurality of cache lines configured to temporarily store data;
an error detection and correction circuit configured to read the data stored in a given one of the cache lines and output a current type indicating one of i) the data has no error, ii) the data had an error that was corrected, and iii) the data has an error that could not be corrected;
a table comprising an entry for each cache line;
an error calculator that generates an error value by accumulating the current type with a previous type received for the one cache line and stores the error value in the entry of the table corresponding to the one cache line; and
a line allocator configured to deny access to the one cache line when the error value in the entry is greater than a predetermined value and otherwise enables access to the one cache line.

17. The memory system of claim 16, wherein the type indicating the data has no error is a first value, the type indicating the data had an error that was corrected is a second value, and the type indicating the data has an error that could not be corrected is a third value, where the first value is less than the second value and the second value is less than the third value.

18. The memory system of claim 17, wherein the line allocator is a logic unit that receives a first signal that indicates whether the error value is greater than the predetermined value and a second signal indicating whether a write is to be performed.

19. The memory system of claim 16, wherein the calculator stores a maximum value supported by the entry in the entry when the error value is greater than the predetermined value.

20. The memory system of claim 16, wherein each entry in the table is cleared when an operating condition of the system changes from a first state to a second other state.
